(19) United States
(12) Patent Application Publication
(10) Pub. No.: US 2020/0208587 A1
(43) Pub. Date: Jul. 2, 2020

(54) KNOCKING DETECTION METHOD AND KNOCKING DETECTION DEVICE

(71) Applicant: MITSUBISHI HEAVY INDUSTRIES ENGINE & TURBOCHARGER, LTD., Sagamihara-shi, Kanagawa (JP)

(72) Inventors: Akihiro YUUKI, Tokyo (JP); Daisuke TAKEMOTO, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 16/623,915

(22) PCT Filed: Oct. 27, 2017
(86) PCT No.: PCT/JP2017/038933

§ 371 Date: Dec. 18, 2019

(51) Int. Cl. F02D 41/14; F02D 41/22; F02D 35/02

(52) U.S. Cl. CPC F02D 41/1498; F02D 35/023; F02D 41/22

(57) ABSTRACT

A method of detecting knocking includes: an in-cylinder pressure obtaining step of obtaining an in-cylinder pressure of a cylinder of the internal combustion engine at a plurality of crank angles; a heat generation rate calculation step of calculating a heat generation rate of the cylinder at each of the plurality of crank angles; an in-cylinder pressure maximizing crank angle obtaining step of obtaining an in-cylinder pressure maximizing crank angle at which the in-cylinder pressure of the cylinder of the internal combustion engine is at a maximum value; a knock determination crank angle region decision step of deciding a knock determination crank angle region which is a region between a smaller crank angle smaller than the in-cylinder pressure maximizing crank angle by a first value and a larger crank angle larger than the in-cylinder pressure maximizing crank angle by a second value; a heat generation rate differentiation step of calculating a differential value of the heat generation rate in the knock determination crank angle region; and a first knocking determination step of determining knocking on the basis of the differential value of the heat generation rate calculated in the heat generation rate differentiation step.

### TECHNICAL FIELD

The present invention relates to a knocking detection method and a knocking detection device.

### BACKGROUND ART

Generally, an internal combustion engine such as a gas engine and a gasoline engine has a higher efficiency when the ignition timing in each combustion cycle is earlier. On the other hand, the earlier the ignition timing, the higher the risk of occurrence of knocking. Knocking is an event of abnormal combustion in which non-combusted end gas self-ignites in a cylinder (spontaneous ignition). The self-ignition generates shock waves, which may break the thermal boundary layer formed on the inner wall surface of the cylinder. As a result, the surface temperature of the inner wall surface of the cylinder may increase excessively, which may cause damage to the internal combustion engine such as melting of engine parts like the cylinder. Thus, it is critical to detect knocking in order to operate the internal combustion engine as efficiently as possible while avoiding damage to the internal combustion engine caused by knocking. In particular, strong knocking may all the more cause damage to the internal combustion engine.

For instance, Patent Documents 1 and 2 disclose detecting knocking by determining knocking on the basis of the intensity of knocking (knocking intensity). In Patent Document 1, the knocking intensity in each combustion cycle is obtained on the basis of signals from an in-cylinder pressure sensor or an acceleration sensor, for instance. Specifically, the knocking intensity is obtained by performing, on the above signals, calculation for obtaining the maximum amplitude, calculation for obtaining partial overall (hereinafter, POA) which is a square sum of the power spectrum density near the knocking frequency by fast Fourier transform analysis (hereinafter, FFT analysis), or calculation for obtaining a value equivalent to POA by integration of waveform signals. Further, Patent Document 2 describes severity, which is a frequency of the POA exceeding a predetermined threshold value. The severity is also used as an evaluation index of the intensity of knocking.

Meanwhile, Patent Document 3 discloses determining knocking on the basis of the heat generation rate inside the combustion chamber of a spark-ignition type internal combustion engine. When knocking occurs, generally, the heat generation rate changes such that the second peak due to knocking appears after the generation peak due to normal combustion (first peak) (see FIG. 5 described below). In Patent Document 3, knocking is detected by determining presence or absence of the second peak that is caused by to knocking. However, the heat generation rate changes repeatedly up and down within a single cycle of combustion, and show a plurality of peaks (see FIG. 5 described below). Thus, it is necessary to tell apart the peak of the heat generation rate that is caused by knocking, from other peaks. To do this, Patent Document 3 discloses determining knocking by detecting and analyzing a region where the heat generation rate reaches zero after the generation peak at the time of normal combustion (first peak) as a fall region of the heat generation rate. That is, there is a premise that the second peak can be observed in the fall region of the heat generation rate when knocking occurs. The knocking determination is carried out by comparing the negative maximum slope of the heat generation rate (maximum differential value of the heat generation rate) in the fall region of the heat generation rate to a threshold value, for instance.

### CITATION LIST

### Patent Literature

Patent Document 1: JP2015-132185A
Patent Document 2: JP2012-159048A
Patent Document 3: JPH2-199257A

### SUMMARY

### Problems to be Solved

As in Patent Documents 1 and 2, in a case where the knocking severity is used as an evaluation index of the intensity of the knocking, the evaluation results often contradict with the typical knocking characteristics that are actually observed. While the knocking severity typically has an increasing trend with progress of the ignition timing, the above described evaluation results include trends where the knocking severity 5 decreases (protrudes upward) or becomes flat from midway with progress of the ignition timing.

Meanwhile, in Patent Document 3, it is critical to accurately detect the above described fall region of the heat generation rate in order to determine knocking accurately. However, as described above, the heat generation rate in the cylinder of the internal combustion engine usually changes repeatedly up and down with a change in the crank angle (see FIGS. 5 and 6 described below), and it is particularly difficult to specify the crank angle at which the heat generation rate becomes zero. Thus, it is difficult to accurately determine the fall region of the heat generation rate. In this regard, Patent Document 3 discloses using a filter to cut the high-frequency vibration component due to knocking or the like. However, such a method may remove components of knocking which are to be detected, and may lead to deterioration of the detection accuracy of knocking.

In view of the above, an object of at least one embodiment of the present invention is to provide a method of detecting knocking capable of more accurately and easily determining knocking on the basis of the heat generation rate in a cylinder of an internal combustion engine.

### Solution to the Problems

(1) According to at least one embodiment of the present invention, a method of detecting knocking in an internal combustion engine includes: an in-cylinder pressure obtaining step of obtaining an in-cylinder pressure of a cylinder of the internal combustion engine at a plurality of crank angles; a heat generation rate calculation step of calculating a heat generation rate of the cylinder at each of the plurality of crank angles; an in-cylinder pressure maximizing crank angle obtaining step of obtaining an in-cylinder pressure maximizing crank angle at which the in-cylinder pressure of the cylinder of the internal combustion engine is at a maximum value; a knock determination crank angle region decision step of deciding a knock determination crank angle region which is a region between a smaller crank angle smaller than the in-cylinder pressure maximizing crank angle by a first value and a larger crank angle larger than the in-cylinder pressure maximizing crank angle by a second value; a heat generation rate differentiation step of calculating a differential value of the heat generation rate in the knock determination crank angle region; and a first knocking determination step of determining knocking on the basis of the differential value of the heat generation rate calculated in the heat generation rate differentiation step.

With the above configuration (1), the knocking detection device is configured to perform knocking determination on the basis of the heat generation rate in the knock determination crank angle region. At this time, the knock determination crank angle region is decided with reference to the in-cylinder pressure maximizing crank angle, which is obtained as the crank angle that maximizes the in-cylinder pressure of the cylinder of the internal combustion engine. Thus, the knock determination crank angle region can be set easily on the basis of the in-cylinder pressure maximizing crank angle can be easily determined from the in-cylinder pressure. Furthermore, by deciding the first value (smaller crank angle) and the second value (larger crank angle) so as to reliably include the crank angle at which knocking is occurring, it is possible to perform knocking determination accurately on the basis of the heat generation rate in the knock determination crank angle region.

(2) In some embodiments, in the above configuration (1), the first value and the second value are each 3 to 7 angular degrees.

The present inventors found that, from intensive researches, it is possible to perform knocking determination accurately by using the differential value of the heat generation rate in the region of ±3 to 7 angular degrees from the in-cylinder pressure maximizing crank angle. Thus, with the above configuration (2), with the knock determination crank angle region being a region where the in-cylinder pressure maximizing crank angle is ±3 to 7 angular degrees, it is possible to improve the accuracy in knocking determination.

(3) In some embodiments, in above configuration (1) or (2), the first knocking determination step includes obtaining a maximum differential heat generation rate which is a maximum value of the differential value of the heat generation rate calculated in the heat generation rate differentiation step, and determining that knocking is present if the maximum differential heat generation rate is greater than a first knock determination threshold value.

With the above configuration (3), by comparing the maximum value of the heat generation rate in the knock determination crank angle region to the threshold value, it is possible to perform knocking determination easily.

(4) In some embodiments, in the above configuration (3), the method further includes a knocking intensity determination step of determining a magnitude of a knocking intensity of the knocking if it is determined that the knocking is present in the first knocking determination step. The knocking intensity determination step includes: a reference differential heat generation rate obtaining step of obtaining a reference differential heat generation rate which is the maximum value of the differential value of the heat generation rate in a reference crank angle region between the smaller crank angle and a crank angle smaller than the smaller crank angle by a third value; and a knock intensity determination step of determining that the knocking intensity is strong if a magnitude of the maximum differential heat generation rate relative to the reference differential heat generation rate is greater than a knock intensity determination threshold value, and that the knocking intensity is weak if the magnitude of the maximum differential heat generation rate relative to the reference differential heat generation rate is not greater than the knock intensity determination threshold value.

With the above configuration (4), it is also possible to determine knocking intensity when it is determined that knocking is present. In this way, for instance, by controlling the ignition timing according to the magnitude of the knocking intensity, it is possible to operate the internal combustion engine as efficiently as possible while avoiding damage to the internal combustion engine due to knocking as much as possible.

(5) In some embodiments, in any one of the above configurations (1) to (4), the method further includes a second knocking determination step of determining that the detected knocking has a strong knocking intensity if a maximum heat generation rate of the heat generation rate is greater than a second knock determination threshold value.

With the above configuration (5), it is possible to detect knocking with a strong knocking intensity quickly. Accordingly, it is possible to prevent damage to the internal combustion engine due to knocking more reliably.

(6) In some embodiments, in any one of the above configurations (1) to (5), the heat generation rate calculation step includes calculating the heat generation rate at each of the plurality of crank angles by using the in-cylinder pressure obtained in the in-cylinder pressure obtaining step.

With the above configuration (6), the in-cylinder pressure is a type of information that is obtained to calculate the in-cylinder pressure maximizing crank angle, and it is possible to obtain the heat generation rate easily from the calculation using the in-cylinder pressure, without using another configuration such as a sensor for obtaining the heat generation rate.

(7) According to at least one embodiment of the present invention, a knocking detection device for detecting knocking in an internal combustion engine including an in-cylinder pressure sensor capable of detecting an in-cylinder pressure of a cylinder of the internal combustion engine and a crank angle sensor capable of detecting a crank angle of the internal combustion device, includes: an in-cylinder pressure obtaining part configured to obtain the in-cylinder pressure detected by the in-cylinder pressure sensor at a plurality of the crank angles; a heat generation rate calculation part configured to calculate a heat generation rate of the cylinder at each of the plurality of crank angles; an in-cylinder pressure maximizing crank angle obtaining part configured to obtain an in-cylinder pressure maximizing crank angle at which the in-cylinder pressure of the cylinder of the internal combustion engine is at a maximum value; a knock determination crank angle region decision part configured to decide a knock determination crank angle region which is a region between a smaller crank angle smaller than the in-cylinder pressure maximizing crank angle by a first value and a larger crank angle larger than the in-cylinder pressure maximizing crank angle by a second value; a heat generation rate differentiation part configured to calculate a differential value of the heat generation rate in the knock determination crank angle region; and a first knocking determination part configured to determine knocking on the basis of the differential value of the heat generation rate calculated by the heat generation rate differentiation part.

With the above configuration (7), similarly to the above (1), it is possible to carry out knocking determination more accurately and easily.

(8) In some embodiments, in the above configuration (7), the first value and the second value are each 3 to 7 angular degrees.

With the above configuration (8), similarly to the above (2), it is possible to improve the accuracy in knocking determination.

(9) In some embodiments, in the above configuration (7) or (8), the first knocking determination part is configured to obtain a maximum differential heat generation rate which is a maximum value of the differential value of the heat generation rate calculated by the heat generation rate differentiation part, and determine that knocking is present if the maximum differential heat generation rate is greater than a first knock determination threshold value.

With the above configuration (9), similarly to the above (3), it is possible to carry out knocking determination easily.

(10) In some embodiments, in the above configuration (9), the knocking detection device further includes a knocking intensity determination part configured to determine a magnitude of a knocking intensity of the knocking if it is determined that the knocking is present by the first knocking determination part. The knocking intensity determination part includes: a reference differential heat generation rate obtaining part configured to obtain a reference differential heat generation rate which is the maximum value of the differential value of the heat generation rate in a reference crank angle region between the smaller crank angle and a crank angle smaller than the smaller crank angle by a third value; and a knock intensity determination part configured to determine that the knocking intensity is strong if a magnitude of the maximum differential heat generation rate relative to the reference differential heat generation rate is greater than a knock intensity determination threshold value, and that the knocking intensity is weak if the magnitude of the maximum differential heat generation rate relative to the reference differential heat generation rate is not greater than the knock intensity determination threshold value.

With the above configuration (10), similarly to the above (4), it is also possible to determine knocking intensity when it is determined that knocking is present. In this way, by controlling the ignition timing according to the magnitude of the knocking intensity, it is possible to operate the internal combustion engine as efficiently as possible while avoiding damage to the internal combustion engine due to knocking.

(11) In some embodiments, in any one of the above configurations (7) to (10), the knocking detection device further includes a second knocking determination part configured to determine that the detected knocking has a strong knocking intensity if a maximum heat generation rate of the heat generation rate is greater than a second knock determination threshold value.

With the above configuration (11), similarly to the above (5), it is possible to detect knocking with a strong knocking intensity quickly. Accordingly, it is possible to prevent damage to the internal combustion engine due to knocking more reliably.

(12) In some embodiments, in any one of the above configurations (7) to (11), the heat generation rate calculation part is configured to calculate the heat generation rate at each of the plurality of crank angles by using the in-cylinder pressure obtained by the in-cylinder pressure obtaining part.

With the above configuration (12), similarly to the above (6), it is possible to obtain the heat generation rate easily without using another configuration such as a sensor for obtaining the heat generation rate.

### Advantageous Effects

According to at least one embodiment of the present invention, it is possible to provide a knocking detection method of detecting knocking which is capable of more accurately and easily determining knocking on the basis of the heat generation rate in a cylinder of an internal combustion engine.

### BRIEF DESCRIPTION OF DRAWINGS

FIG. 1 is a schematic configuration diagram of an internal combustion engine including a knocking detection device for implementing a knocking detection method according to an embodiment of the present invention.

FIG. 2 is a functional block diagram showing a configuration of a knocking detection device according to an embodiment of the present embodiment.

FIG. 3 is a flowchart showing a knocking detection method according to an embodiment of the present invention.

FIG. 4 is a diagram illustrating an in-cylinder pressure change curve in a cylinder of an internal combustion engine according to an embodiment of the present invention.

FIG. 5 is a diagram showing a heat generation rate change curve obtained on the basis of the in-cylinder pressure change curve in FIG. 4.

FIG. 6 is a diagram showing a heat generation rate differentiation curve obtained by differentiating the heat generation rate change curve in FIG. 5.

FIG. 7 is a functional block diagram showing a configuration of a knocking detection device according to an embodiment of the present embodiment, where the knocking detection device further includes the second knocking determination part.

FIG. 8 is a flowchart showing a knocking detection method according to an embodiment of the present invention, where the knocking detection method further includes the second knocking determination step.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

On the other hand, an expression such as “comprise”, “include”, “have”, “contain” and “constitute” are not intended to be exclusive of other components.

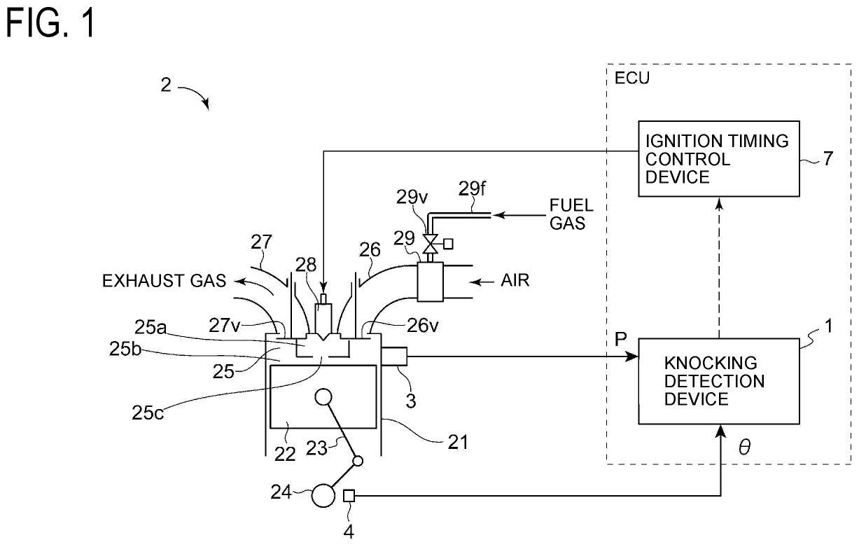

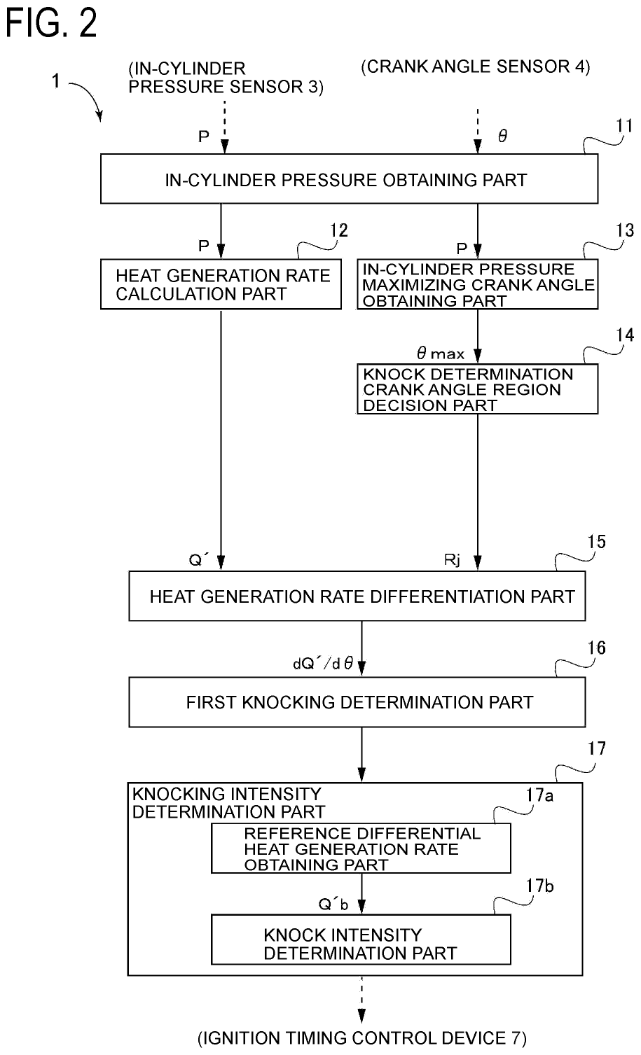

FIG. 1 is a schematic configuration diagram of an internal combustion engine 2 including a knocking detection device 1 for implementing a knocking detection method according to an embodiment of the present invention. FIG. 2 is a functional block diagram showing the configuration of the knocking detection device 1 according to some embodiments of the present embodiment.

First, the internal combustion engine 2 depicted in FIGS. 1 and 2 will be described. The internal combustion engine includes a cylinder 21 and a piston 22 that reciprocates inside the cylinder 21. The piston 22 is connected mechanically to a crank shaft 24 via a connection rod 23. The space defined by the upper surface of the piston 22 and the capacity part of the cylinder 21 is a combustion chamber 25. Normally, the internal combustion engine 2 includes a plurality of cylinders 21, and the above described in-cylinder pressure sensor 3 is provided for each cylinder 21 and detects the in-cylinder pressure P for each cylinder 21. While only one cylinder 21 is depicted in FIG. 1, the number of the cylinders 21 may be one or more, and the internal combustion engine 2 may be a single-cylinder engine or a multi-cylinder engine. Furthermore, the internal combustion engine 2 may be a gas engine or a gasoline engine, for instance.

Furthermore, to the cylinder 21, an air supply pipe 26 for supplying gas mixture of air and fuel to the combustion chamber 25, and an air discharge pipe 27 for discharging combustion gas (exhaust gas) from the combustion chamber 25 are connected. Furthermore, a mixer 29 for mixing air and fuel that flow toward the combustion chamber 25 from the upstream side of the air supply pipe 26 is disposed in the air supply pipe 26. The fuel gas is supplied to the mixer 29 from a fuel supply pipe 29f connected to the mixer 29, while a fuel adjustment valve 29v adjusts the fuel supply amount of the fuel gas. Further, an air supply valve 26v for controlling the communication state between the combustion chamber 25 and the air supply pipe 26, an air discharge valve 27v for controlling the communication state between the combustion chamber 25 and the air discharge pipe 27, and an ignition plug 28 are disposed in the combustion chamber 25. Furthermore, as depicted in FIG. 1, the combustion chamber 25 may include a pre-combustion chamber 25a including an ignition plug 28 inside thereof, and a main chamber 25b which is in communication with the pre-combustion chamber 25a via a nozzle hole 25c. In this case, a small amount of fuel gas supplied to the pre-combustion chamber 25a for generating a torch is directly ignited by the ignition plug, and the torch that is injected from the nozzle hole 25c by ignition inside the pre-combustion chamber 25a ignites the gas mixture that exists in the main chamber 25b.

In the embodiments depicted in FIGS. 1 and 2, as depicted in the drawings, the internal combustion engine 2 includes an in-cylinder pressure sensor 3 capable of detecting the in-cylinder pressure P of cylinders of the internal combustion engine 2, and a crank angle sensor 4 capable of detecting the crank angle θ of the crank shaft 24 of the internal combustion engine (hereinafter, merely referred to as the crank angle θ). The crank angle sensor 4 is disposed in the crank shaft 24, and is thereby configured to detect a phase angle of the crank shaft 24 and output a signal representing the current crank angle phase (crank angle phase signal) to the knocking detection device 1. Furthermore, the in-cylinder pressure sensor 3 is disposed on the cylinder 21, and thereby detects and outputs signals representing the pressure inside the combustion chamber 35 (in-cylinder pressure signal) to the knocking detection device 1.

Next, the knocking detection device 1 according to an embodiment of the present invention will be described with reference to FIGS. 2 to 5. The knocking detection device 1 obtains the heat generation rate, which is a heat generation amount (Q) per a unit crank angle (dQ/dθ; hereinafter, the heat generation rate will be merely referred to as Q′), and determines knocking on the basis of the heat generation rate Q′, thereby detecting knocking. In the following description, the heat generation rate Q′ is calculated by using the in-cylinder pressure P of the cylinder of the internal combustion engine 2.

In some embodiments, as depicted in FIG. 2, the knocking detection device 1 includes an in-cylinder pressure obtaining part 11, a heat generation rate calculation part 12, an in-cylinder pressure maximizing crank angle obtaining part 13, a knock determination crank angle region decision part 14, a heat generation rate differentiation part 15, and a first knocking determination part 16. The knocking detection device 1 includes a computer such as an electronic control device (ECU), which includes a CPU (processor, not depicted) and a memory (storage device) such as ROM and RAM. The CPU operates (e.g., computation of data) in accordance with program instructions loaded to a main storage device, and thereby the above functional parts of the above described knocking detection device 1 are implemented.

In the embodiments depicted in FIGS. 1 and 2, the knocking detection device 1 is capable of communicating with an ignition timing control device 7 that controls the ignition timing of the internal combustion engine 2, and is configured to output results of knocking detection to the ignition timing control device 7. Further, the ignition timing control device 7 is configured to control the ignition timing by the ignition plug 28 to the retard angle side if a signal indicating detection of knocking is input from the knocking detection device 1.

Next, each of the above configurations of the above described knocking detection device 1 will be described.

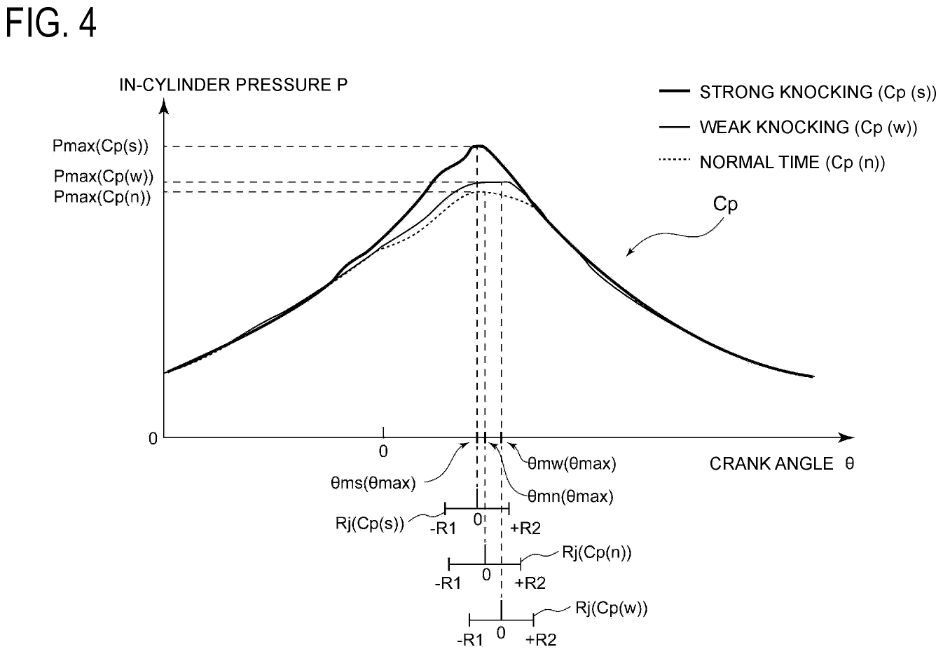

The in-cylinder pressure obtaining part 11 obtains the in-cylinder pressure P detected by the in-cylinder pressure sensor 3 at a plurality of crank angles θ. The crank-angle θ is, for instance, a rotation angle of the internal combustion engine 2 from a reference, where the reference is the top dead point (zero degrees) of the piston 22 of the cylinder 21. In the embodiments depicted in FIGS. 1 and 2, the in-cylinder pressure obtaining part 11 is connected to each of the in-cylinder pressure sensor 3 and the crank angle sensor 4, and thereby receives the in-cylinder pressure signals and the crank-angle phase signals. Further, the in-cylinder pressure obtaining part 11 reads in (obtains) the in-cylinder pressure P (data) in a region (monitoring crank angle region R) that includes a region (knock determination crank angle region Rj described below) of a crank angle θ that possibly includes a signal due to knocking occurring in a combustion cycle of the internal combustion engine 2. For instance, when the top dead center is the reference (zero angular degrees) of the crank angle θ, a predetermined crank angle θ at minus 30 to minus 60 angular degrees from the top dead center in the combustion stroke may be set as the lower limit crank angle of the monitoring crank angle region R, and a predetermined crank angle θ at plus 30 to plus 60 angular degrees from the top dead center may be set as the upper limit crank angle of the monitoring crank angle region R (lower limit crank angle ≤monitoring crank angle region R≤upper limit crank angle). However, the present invention is not limited to this embodiment. In some other embodiments, the monitoring crank angle region R may be the entire region of the combustion cycle of the internal combustion engine 2. The in-cylinder pressure P changes with progress of the crank angle θ, and thereby obtained is an in-cylinder pressure change curve Cp (see FIG. 4 described below) showing the relationship between the crank angle θ and the in-cylinder pressure P.

Further, the in-cylinder pressure obtaining part 11 is configured to output the obtained relationship between the crank angle θ and the in-cylinder pressure P (in-cylinder pressure change curve Cp) to the heat generation rate calculation part 12 and the in-cylinder pressure maximizing crank angle obtaining part 13 described below.

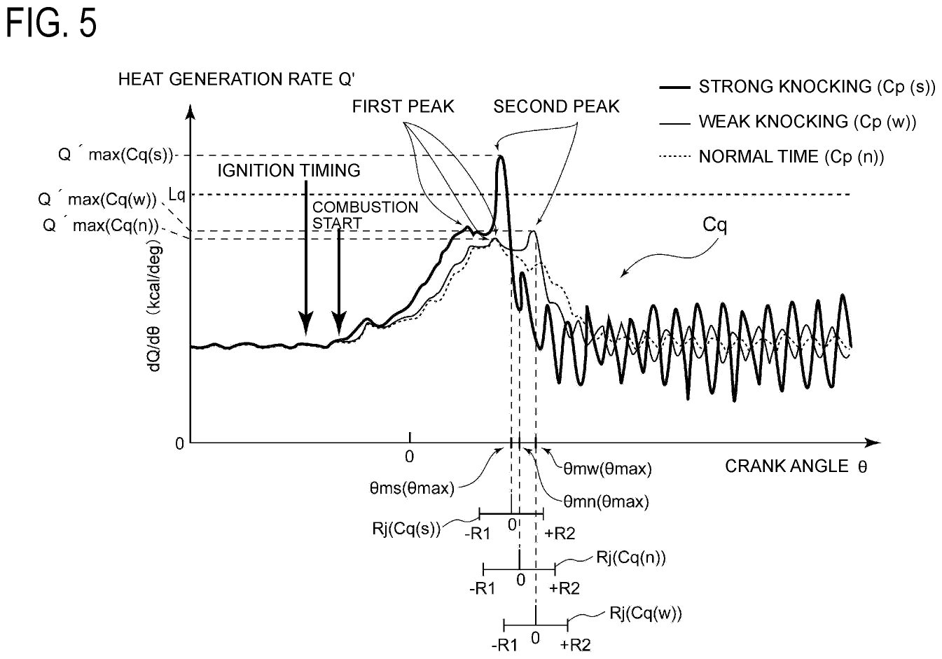

The heat generation rate calculation part 12 calculates the heat generation rate Q′ of the cylinder at each of the plurality of crank angles obtained by the in-cylinder pressure obtaining part 11. As already known, the in-cylinder pressure P has a correlated relationship with the heat generation amount Q generated from combustion of gas mixture inside the combustion chamber 25, and thus it is possible to obtain the heat generation rate Q′ from the in-cylinder pressure P. In the embodiment depicted in FIGS. 1 and 2, the heat generation rate calculation part 12 is connected to the in-cylinder pressure obtaining part 11. Further, the heat generation rate calculation part 12 calculates the heat generation rate Q′ at a predetermined interval of the crank angle θ, such as one angular degree. Accordingly, it is possible to obtain the heat generation rate change curve Cq (see FIG. 5 described below) showing the relationship between the crank angle θ and the heat generation rate Q′. Furthermore, in some other embodiments, the heat generation rate calculation part 12 may be connected to the knock determination crank angle region decision part 14 described below, and thereby configured to calculate only the heat generation rate Q′ in the knock determination crank angle region Rj (described below).

The in-cylinder pressure maximizing crank angle obtaining part 13 obtains the in-cylinder pressure maximizing crank angle θmax at which the in-cylinder pressure P of the cylinder of the internal combustion engine 2 reaches its maximum. In the embodiment depicted in FIGS. 1 and 2, the in-cylinder pressure maximizing crank angle obtaining part 13 is connected to the in-cylinder pressure obtaining part 11. Further, the in-cylinder pressure maximizing crank angle obtaining part 13 determines the maximum value Pmax of the in-cylinder pressure P at the plurality of crank angles θ inputted from the in-cylinder pressure obtaining part 11 (in-cylinder pressure change curve Cp), and obtains, as the in-cylinder pressure maximizing crank angle θmax, the crank angle θ at which the in-cylinder pressure P is at the maximum value Pmax.

The knock determination crank angle region decision part 14 decides a knock determination crank angle region Rj, which is a region between a smaller crank angle θs that is smaller than the in-cylinder pressure maximizing crank angle θmax by the first value R1 and a larger crank angle θb larger than the in-cylinder pressure maximizing crank angle θmax by the second value R2. That is, the knock determination crank angle region Rj is a region of the crank angle θ decided with reference to the in-cylinder pressure maximizing crank angle θmax. In the embodiment depicted in FIGS. 1 and 2, the knock determination crank angle region decision part 14 is connected to the in-cylinder pressure maximizing crank angle obtaining part 13. The knock determination crank angle region decision part 14 calculates the smaller crank angle θs by subtracting the first value R1 from the in-cylinder pressure maximizing crank angle θmax inputted from the in-cylinder pressure maximizing crank angle obtaining part 13, and calculates the larger crank angle θb by adding the second value R2 to the in-cylinder pressure maximizing crank angle θmax, thereby deciding the knock determination crank angle region Rj (θs≤Rj≤θb).

The knocking determination is carried out through analysis of the knock determination crank angle region Rj by the heat generation rate differentiation part 15 and the first knocking determination part 16, as described below.

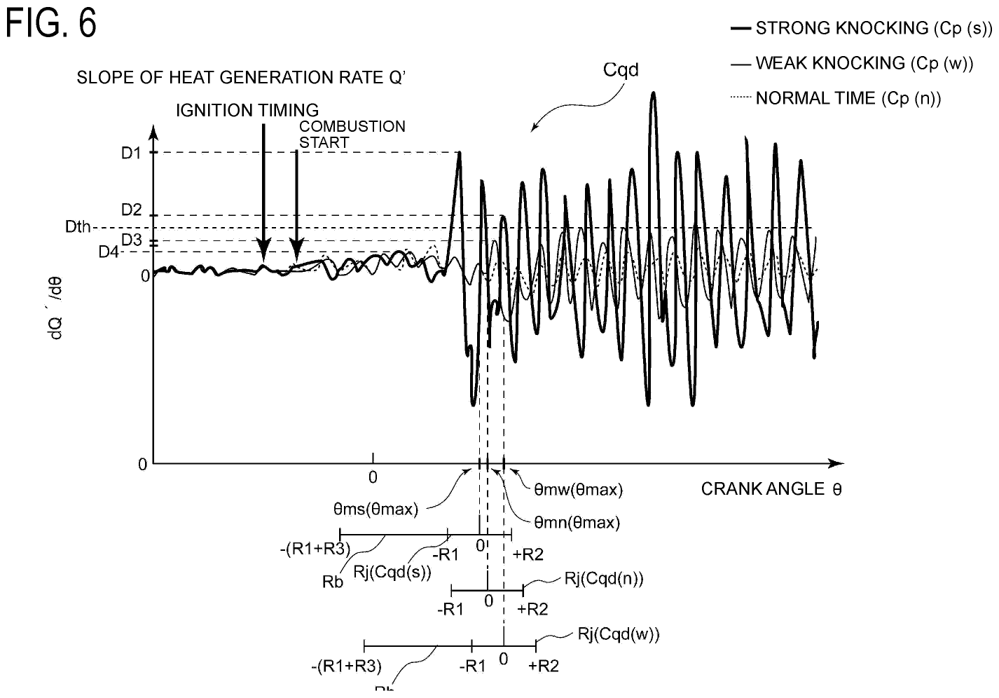

The heat generation rate differentiation part 15 calculates the differential value of the heat generation rate Q′ in the knock determination crank angle region Rj (d (dQ/dθ)/dθ). In other words, the heat generation rate differentiation part 15 calculates the slope amount of the heat generation rate Q′. In the embodiments depicted in FIGS. 1 and 2, the heat generation rate differentiation part 15 is connected to each of the heat generation rate calculation part 12 and the knock determination crank angle region decision part 14. Further, the heat generation rate differentiation part 15 differentiates the heat generation rate Q′ which is input from the heat generation rate calculation part 12 and which is in the knock determination crank angle region Rj input from the knock determination crank angle region decision part 14. Accordingly, it is possible to obtain the heat generation rate differentiation curve Cqd (see FIG. 6 described below) showing the relationship between the crank angle θ and the differential value of the heat generation rate Q′ in the knock determination crank angle region Rj.

The first knocking determination part 16 performs knocking determination on the basis of the differential value of the heat generation rate Q′ in the knock determination crank angle region Rj calculated by the heat generation rate differentiation part 15. In the embodiments depicted in FIGS. 1 and 2, the first knocking determination part 16 is connected to the heat generation rate differentiation part 15, and receives the relationship between the crank angle θ and the differential value of the heat generation rate Q′ (heat generation rate differentiation curve Cqd). More specifically, in the embodiment depicted in FIGS. 1 and 2, the first knocking determination part 16 obtains the maximum differential heat generation rate, which is the maximum value of the differential value of the heat generation rate Q′ calculated by the heat generation rate differentiation part 15, and determines that knocking is present if the maximum differential heat generation rate is greater than the first knock determination threshold value Dth. By comparing the maximum value of the differential value of the heat generation rate Q′ in the knock determination crank angle region Rj to the threshold value (first knock determination threshold value Dth), it is possible to perform knocking determination easily.

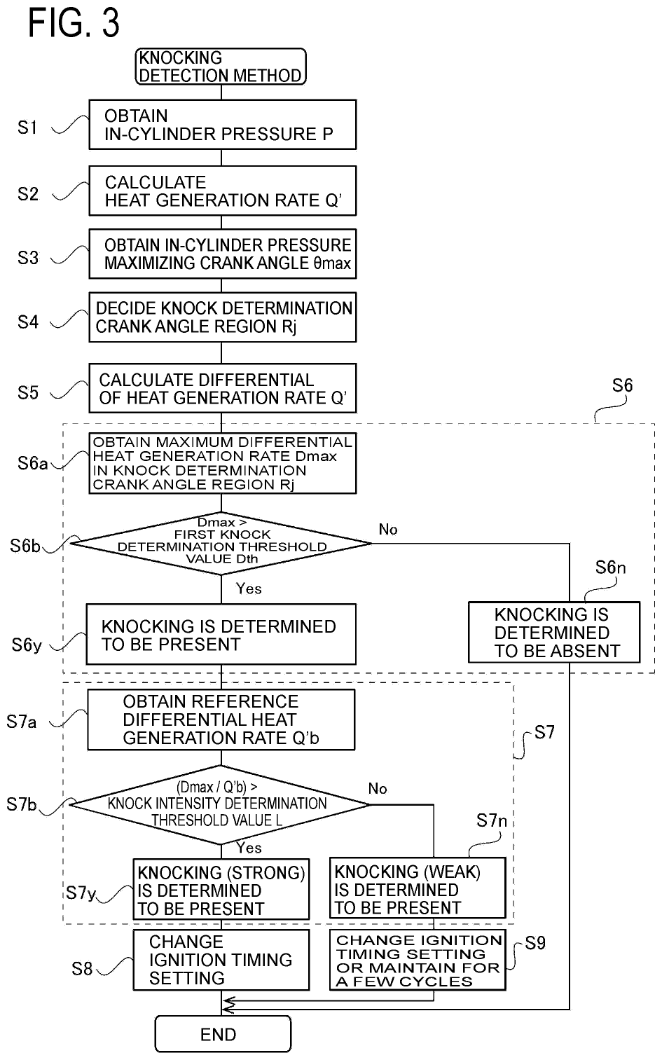

Next, the knocking detection method to be executed by the knocking detection device 1 having the above configuration, for instance, will be described with reference to FIGS. 3 to 6. FIG. 3 is a flowchart showing a knocking detection method according to an embodiment of the present invention. FIG. 4 is a diagram illustrating the in-cylinder pressure change curve Cp in a cylinder (cylinder 21) of the internal combustion engine 2 according to an embodiment of the present invention. FIG. 5 is a diagram showing the heat generation rate change curve Cq obtained on the basis of the in-cylinder pressure change curve Cp in FIG. 4. FIG. 5 is a diagram showing the heat generation rate differentiation curve Cqd obtained by differentiating the heat generation rate change curve Cq in FIG. 5.

As depicted in FIG. 3, the knocking detection method is for detecting knocking in the internal combustion engine 2, and includes an in-cylinder obtaining step (S1), a heat generation rate calculation step (S2), an in-cylinder pressure maximizing crank angle obtaining step (S3), a knock determination crank angle region decision step (S4), a heat generation rate differentiation step (S5), and a first knocking determination step (S6).

Next, the above described steps will be described in the order of execution of the flow depicted in FIG. 3.

In step S1 of FIG. 3, the in-cylinder pressure obtaining step is performed. This step is a step for carrying out what corresponds to the process of the above described in-cylinder pressure obtaining part 11. In the in-cylinder pressure obtaining step (S1), the above described in-cylinder pressure sensor 3 and the crank angle sensor 4 are used, for instance, to obtain the in-cylinder pressure P of the cylinder of the internal combustion engine 2 at a plurality of crank angles θ. Further, by carrying out the above step, in-cylinder pressure change curves Cp as depicted in FIG. 4 is obtained. In FIG. 4, three types of curves are illustrated: the in-cylinder pressure change curve Cp (n) at the normal time when knocking is not occurring, indicated by the dotted line; the in-cylinder pressure change curve Cp (s) at the time of strong knocking when strong knocking is occurring that increases the risk of damage to the internal combustion engine 2, indicated by the thick solid line; and the in-cylinder pressure change curve Cp (w) at the time of weak knocking when weaker knocking than the above strong knocking is occurring, indicated by the thin solid line.

In step S2, the heat generation rate calculation step is performed. This step is a step for carrying out what corresponds to the process of the above described heat generation rate calculation part 12. In the heat generation rate calculation step (S2), the heat generation rate Q′ of the cylinder at each of a plurality of crank angles is calculated. Further, by carrying out the above step, the heat generation rate change curve Cq as depicted in FIG. 5 is obtained. As indicated by the heat generation rate change curve Cq in FIG. 5, the heat generation rate Q′ changes repeatedly up and down within a single cycle of combustion, and each of the three heat generation rate change curves Cq has a peak (first peak) of the heat generation rate Q′ due to combustion that occurs from ignition of the ignition plug 28. Also, if knocking occurs, the second peak of the heat generation rate Q′ due to knocking appears at a crank angle θ after the first peak. Furthermore, the peak value of the second peak of the heat generation rate Q′ tends to increase with an increase in the knocking intensity. In the embodiment depicted in FIG. 3, by using the in-cylinder pressure P obtained in the in-cylinder pressure obtaining step (S1), the heat generation rate Q′ in the monitoring crank angle region R is calculated at each of the plurality of crank angles θ.

In step S3, the in-cylinder pressure maximizing crank angle obtaining step is performed. This step is a step for carrying out what corresponds to the process of the above described in-cylinder pressure maximizing crank angle obtaining part 13. In the in-cylinder pressure maximizing crank angle obtaining step (S3), the in-cylinder pressure maximizing crank angle θmax that maximizes the in-cylinder pressure P of the cylinder of the internal combustion engine 2 is obtained. In the embodiment depicted in FIG. 3, the in-cylinder pressure maximizing crank angle θmax in the monitoring crank angle region R obtained in the in-cylinder pressure obtaining step (S2) is obtained. In the example of FIG. 4, the maximum value (Pmax) of the in-cylinder pressure P increases in the following order: at the normal time (Pmax of Cp (n)), at the time of weak knocking (Pmax of Cp (w)), and then at the time of strong knocking (Pmax of Cp (s)). Further, the crank angle θ corresponding to each of the above maximum values of the in-cylinder pressure P (in-cylinder pressure maximizing crank angle θmax) is θmn at the normal time, θmw at the time of weak knocking, and θms at the time of strong knocking.

In step S4, the knock determination crank angle region decision step is executed. This step is a step for carrying out what corresponds to the process of the above described knock determination crank angle region decision part 14. In the knock determination crank angle region decision step (S4), the above described knock determination crank angle region Rj is decided. That is, the knock determination crank angle region Rj is a region between ‘θmax−the first value R1’ and ‘θmax+the second value R2’ (θmax− R1≤Rj≤θmax+R2). In the example of FIG. 4, the knock determination crank angle region Rj is θmn−R1≤Rj (Cp (n))≤θmn+R2 at the normal time, θmw−R1≤Rj (Cp (w))≤θmn+R2 at the time of weak knocking, and θms−R1≤Rj (Cp (s))≤θms+R2 at the time of strong knocking. (See FIG. 4).

In step S5, the heat generation rate differentiation step is performed. This step is a step for carrying out what corresponds to the process of the above described heat generation rate differentiation part 15. In the heat generation rate differentiation step (S5), the differential value of the heat generation rate Q′ in the knock determination crank angle region Rj is calculated. That is, from the heat generation rate change curve Cq depicted in FIG. 5, the heat generation rate differentiation curve Cqd depicted in FIG. 6 is obtained. In FIG. 6, in accordance with FIGS. 4 and 5, as described above, following three types of curves are shown: the heat generation rate differentiation curve Cqd (n) at the normal time indicated by the dotted line, the heat generation rate differentiation curve Cqd (s) at the time of strong knocking indicated by the thick solid line, and the heat generation rate differentiation curve Cqd (w) at the time of weak knocking indicated by the thin solid line. Naturally, the heat generation rate differentiation curve Cqd (FIG. 6) changes repeatedly up and down within a single cycle of combustion, similarly to the heat generation rate change curve Cq (FIG. 5). In the example of FIG. 6, the change (slope) of the heat generation rate Q′ of each of the three heat generation rate differentiation curves Cqd increases after starting combustion compared to that before starting combustion. Furthermore, the above change of the heat generation rate Q′ is more significant when the knocking is strong compared to when the knocking is weak.

In step S6 (S6a, S6b, S6y, S6n), the first knocking determination step is performed. This step is a step for carrying out what corresponds to the process of the above described first knocking determination part 16. In the first knocking determination step (S6), knocking determination is performed on the basis of the differential value of the heat generation rate Q′ calculated in the heat generation rate differentiation step (S5). In the embodiment depicted in FIG. 3, in step S6a, the maximum differential heat generation rate Dmax, which is the maximum value of the differential value of the heat generation rate Q′ calculated in the heat generation rate differentiation step (S5) is obtained. Then, in step S6b, the maximum differential heat generation rate Dmax and the first knock determination threshold value Dth are compared. As a result of the above comparison, if the maximum differential heat generation rate Dmax is greater than the first knock determination threshold value Dth, it is determined, in step S6y, that knocking is present. In contrast, if the maximum differential heat generation rate Dmax is not greater than the first knock determination threshold value Dth, it is determined, in step S6n, that knocking is absent.

In the example of FIG. 6, the maximum differential heat generation rate Dmax in the knock determination crank angle region Rj of the crank angle θ is D3 at the normal time indicated by the dotted line, D2 at the time of weak knocking indicated by the thin solid line, and D1 at the time of strong knocking indicated by the thick solid line. D1 is greater than D2, and D2 is greater than D3 (D1>D2>D3). Furthermore, the first knock determination threshold value Dth is set to a value smaller than D1 and D2, and greater than D3. Thus, knocking is determined to be present for the heat generation rate differentiation curve Cqd (s) (when knocking is strong) and the heat generation rate differentiation curve Cqd (w) (when knocking is weak) where the maximum differential heat generation rate Dmax is D1 and D2, respectively. In contrast, knocking is determined to be absent for the heat generation rate differentiation curve Cqd (n) (the normal time) where the maximum differential heat generation rate Dmax is D3.

The knocking detection device 1 and the knocking detection method according to an embodiment of the present invention have been described. With the above configuration, the knocking detection device 1 is configured to perform knocking determination on the basis of the heat generation rate Q′ in the knock determination crank angle region Rj. At this time, the knock determination crank angle region Rj is decided with reference to the in-cylinder pressure maximizing crank angle θmax, which is obtained as the crank angle θ that maximizes the in-cylinder pressure P of the cylinder of the internal combustion engine 2. Thus, the knock determination crank angle region Rj can be set easily on the basis of the in-cylinder pressure maximizing crank angle θmax that can be easily determined from the in-cylinder pressure P. Furthermore, by deciding the first value R1 (smaller crank angle θs) and the second value R2 (larger crank angle θb) so as to reliably include the crank angle θ at which knocking is occurring, it is possible to perform knocking determination accurately on the basis of the heat generation rate Q′ in the knock determination crank angle region Rj.

Furthermore, in some embodiments, the first value R1 and the second value R2 for defining the knock determination crank angle region Rj is each 3 to 7 angular degrees. Preferably, the first value R1 and the second value R2 are each in the range of 4 to 6 angular degrees, and more preferably, are 5 angular degrees. For instance, when the first value R1 and the second value R2 are each 5 angular degrees, the knock determination crank angle region Rj is a region where the crank angle θ is between ‘θmax−5 angular degrees’ and ‘θmax+5 angular degrees’ (θmax−5°≤RJ≤θmax+5°). In the example of FIG. 4, the in-cylinder pressure maximizing crank angle θmax is θmn in the in-cylinder pressure change curve Cp (n) at the normal time, θms in the in-cylinder pressure change curve Cp (s) at the time of strong knocking, and θmw in the in-cylinder pressure change curve Cp (w) at the time of weak knocking. Thus, the knock determination crank angle region Rj is θmn−5°≤RJ (Cp (n))≤θmn+5° at the normal time, θms−5°≤RJ (Cp (s))≤θms+5° at the time of strong knocking, and θmw−5°≤RJ (Cp (w))≤θmw+5° at the time of weak knocking. Although the first value R1 and the second value R2 are the same value, 5 angular degrees, in the above description, the first value R1 and the second value R2 may be different from one another.

The above described knock determination crank angle region Rj is a region of the crank angle θ where the present inventors found that, from intensive researches, it is possible to perform knocking determination accurately by using the differential value of the heat generation rate Q′ in the region of ±3 to 7 angular degrees from the in-cylinder pressure maximizing crank angle θmax. Thus, with the above configuration, with the knock determination crank angle region Rj being a region of ±3 to 7 angular degrees from the in-cylinder pressure maximizing crank angle θmax (preferably ±4 to 6 angular degrees, more preferably 5 angular degrees), it is possible to improve the knocking determination accuracy.

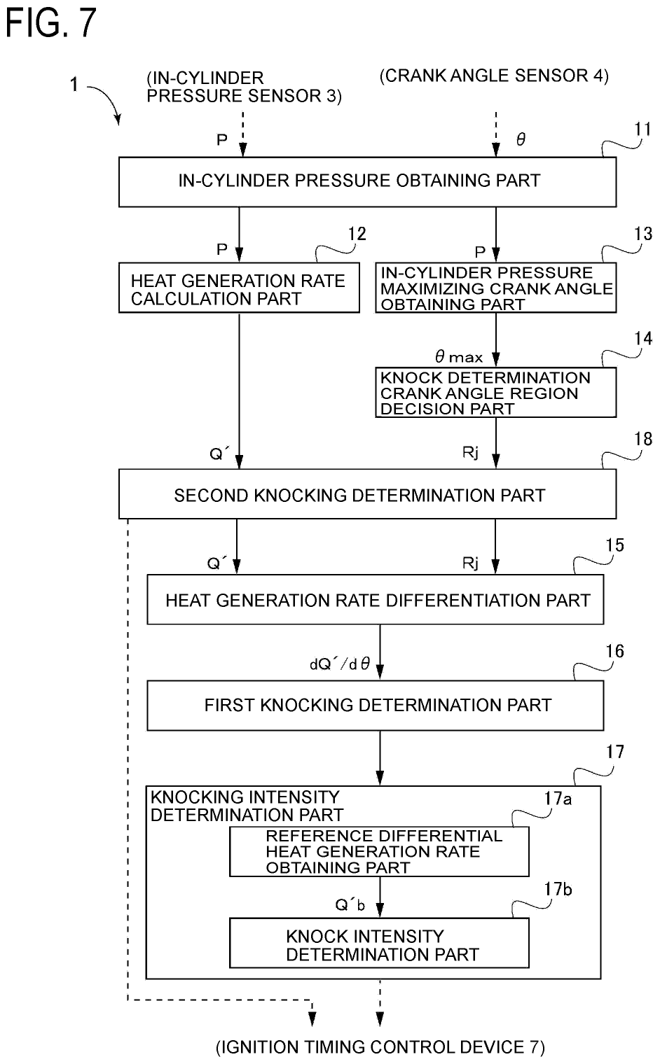

In some embodiments, as depicted in FIG. 2 (and also FIG. 7 described below), the knocking detection device 1 may further include a knocking intensity determination part 17 that determines the magnitude of the knocking intensity of detected knocking, if the first knocking determination part 16 determines that knocking is present. The knocking intensity determination part 17 includes a reference differential heat generation rate obtaining part 17a that obtains a reference differential heat generation rate Q′b which is the maximum value of the differential value of the heat generation rate Q′ in a reference crank angle region Rb between a crank angle θ smaller than the above described smaller crank angle θ by the third value R3 and the smaller crank angle θ, and a knock intensity determination part 17b that determines that the knocking intensity is strong if the magnitude of the maximum differential value heat generation rate Dmax relative to the reference differential heat generation rate Q′b is greater than the knock intensity determination threshold value L, and that the knocking intensity is weak if the magnitude of the maximum differential heat generation rate Dmax relative to the reference differential heat generation rate Q′b is not greater than the knock intensity determination threshold value L. That is, the above described reference crank angle region Rb is a region adjoining to the smaller side of the crank angle θ of the knock determination crank angle region Rj (where the crank angle θ is zero angular degrees as seen from the in-cylinder pressure maximizing crank angle θmax in FIG. 6), where the change in the differential value of the heat generation rate Q′ is relatively small, before the differential value of the heat generation rate Q′ changes considerably due to occurrence of knocking. Further, the magnitude of intensity is determined on the basis of comparison of the knock intensity determination threshold value L to ‘the maximum differential heat generation rate Dmax/the reference differential heat generation rate Q′b’.

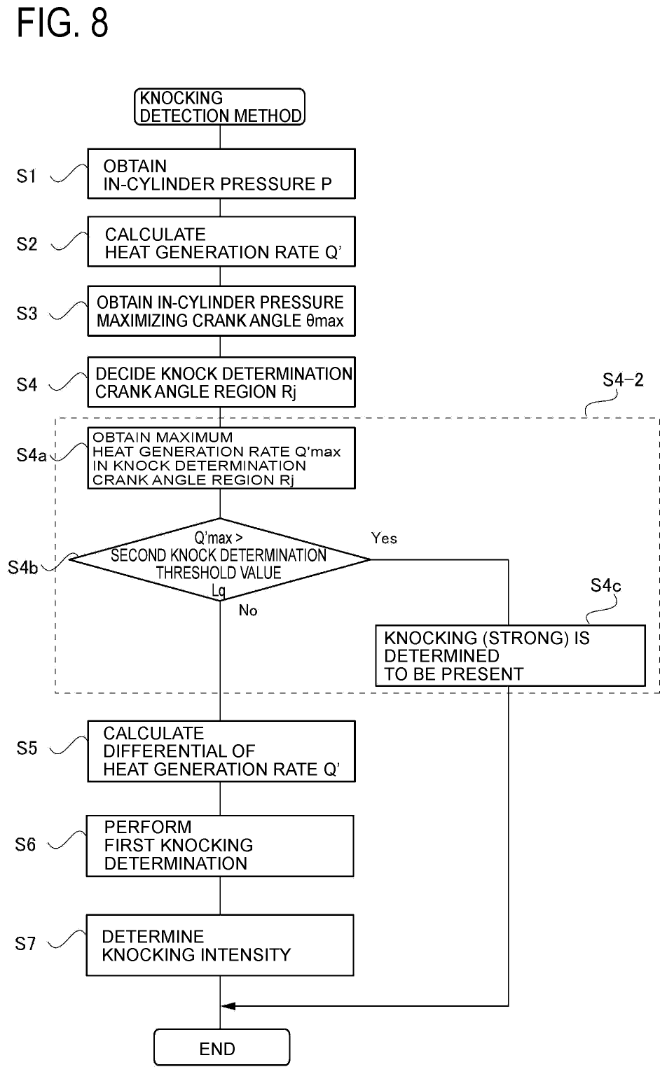

The knocking detection method corresponding to the above embodiment will now be described. As depicted in FIG. 3 (and also FIG. 8 described below), the knocking detection method further includes a knocking intensity determination step (S7) of determining the magnitude of the knocking intensity of knocking that is detected to be present, if it is determined that knocking is present in the first knocking determination step described above (step S6y). More specifically, the knocking intensity determination step (S7) includes a reference differential heat generation rate obtaining step (S7a) of obtaining the reference differential heat generation rate Q′b which is the maximum value of the differential value of the heat generation rate Q′ in the reference crank angle region Rb between a crank angle θ smaller than the above described smaller crank angle θ by the third value R3 and the smaller crank angle θ, and a knock intensity determination step (S7b, S7y, S7n) of determining that the knocking intensity is strong if the magnitude of the maximum differential value heat generation rate Dmax relative to the reference differential heat generation rate Q′b is greater than the knock intensity determination threshold value L, and that the knocking intensity is weak if the magnitude of the maximum differential heat generation rate Dmax relative to the reference differential heat generation rate Q′b is not greater than the knock intensity determination threshold value L. The above described reference differential heat generation rate obtaining step (S7a) is a step of carrying out what corresponds to the process of the above described reference differential heat generation rate obtaining part 17a. Furthermore, the knock intensity determination step (S7b, S7y, S7n) is a step of carrying out what corresponds to the process of the above described knock intensity determination part 17b.

The knocking intensity determination step (S7) will be described with reference to the flow in FIG. 3. Next to the above described step Shy, the knocking intensity determination step (S7) is executed. That is, the reference differential heat generation rate obtaining step is executed in step S7a, and in the next step S7b, the magnitude of the maximum differential heat generation rate Dmax relative to the reference differential heat generation rate Q′b (Dmax/Q′b) is compared to the knock intensity determination threshold value L. Furthermore, if the comparison result in step S7b is Yes (Dmax/Q′b>L), it is determined that the knocking intensity is strong, in step S7y. In contrast, if the comparison result in step S7b is No (Dmax/Q′b≤L), it is determined that the knocking intensity is weak, in step S7n.

In the embodiment depicted in FIGS. 1 to 3, the third value R3 is 15 angular degrees. Further, in the example of FIG. 6, at both times when knocking is strong and when knocking is weak, the reference differential heat generation rate Q′b is D4. Furthermore, as a result of comparison of the maximum differential heat generation rate Dmax/Q′b and the knock intensity determination threshold value L, when knocking is strong, it is determined that the knocking intensity is strong if an expression D1/D4>L is satisfied, and when knocking is weak, it is determined that the knocking intensity is weak if an expression D2/D4≤L is satisfied.

In the embodiment depicted in FIG. 3, if it is determined that the knocking intensity is strong in step S7y, in the subsequent step S8, the ignition timing is changed immediately, such as retarding the ignition timing. This is to prevent damage to the internal combustion engine 2 due to strong knocking quickly. In contrast, if it is determined that the knocking intensity is weak in step S7n, in the subsequent step S9, the ignition timing may be changed immediately such as retarding the ignition timing, or, the steps S1 to S7b in FIG. 3 may be repeated as many times as a predetermined combustion cycles, and then the ignition timing may be changed such as retarding the ignition timing after the result of repeating the steps S1 to S7b. This is to, since the efficiency of the internal combustion engine 2 improves when the igniting timing in each combustion cycle is earlier, change the ignition timing or the like taking into account the frequency and succession of detection of weak knocking, and to prioritize the high-efficiency operation of the internal combustion engine 2 as much as possible.

With the above configuration, it is also possible to determine knocking intensity when it is determined that knocking is present. In this way, for instance, by controlling the ignition timing according to the magnitude of the knocking intensity, it is possible to operate the internal combustion engine 2 as efficiently as possible while avoiding damage to the internal combustion engine 2 due to knocking as much as possible.

Next, some other embodiments of knocking determination and intensity determination will be described with reference to FIGS. 7 and 8. FIG. 7 is a functional block diagram showing a configuration of a knocking detection device according to some embodiments of the present embodiment, where the knocking detection device 1 further includes the second knocking determination part 18. FIG. 8 is a flowchart showing a knocking detection method according to an embodiment of the present invention, where the knocking detection method further includes the second knocking determination step. While FIGS. 7 and 8 include functional parts or method steps that correspond to FIGS. 2 and 3, respectively, the same description will be omitted for those indicated by the same reference numerals.

In the embodiment depicted in FIGS. 1 to 3, knocking determination and intensity determination are performed on the basis of the differential value of the heat generation rate Q′. In some other embodiments, as depicted in FIGS. 7 and 8, knocking determination and intensity determination may be performed on the basis of the heat generation rate Q′. This is, as depicted in FIG. 5, strong knocking is likely to be occurring if the maximum value of the heat generation rate Q′ is too large, and it is possible to determine knocking more quickly by using the heat generation rate Q′ without calculating the differential value of the heat generation rate Q′.

Specifically, as depicted in FIG. 7, the knocking detection device 1 further includes a second knocking determination part 18 that determines that knocking with a strong knocking intensity is detected, if the maximum heat generation rate Q′max is greater than the second knock determination threshold value Lq. In the embodiment depicted in FIG. 7, the second knocking determination part 18 is disposed on the previous stage of the first knocking determination part 16. More specifically, the second knocking determination part 18 is connected to each of the heat generation rate calculation part 12 and the knock determination crank angle region decision part 14, and performs knocking determination by comparing the maximum value of the heat generation rate Q′ in the knock determination crank angle region Rj to the second knock determination threshold value Lq. Furthermore, the second knocking determination part 18 is configured to notify, when determining that knocking (strong) is present, the ignition timing control device 7 of the determination result without waiting for the determination result by the first knocking determination part 16. In contrast, if the second knocking determination part 18 does not determine that knocking (strong) is present, the first knocking determination part 16 performs knocking determination.

However, in some embodiments, the first knocking determination part 16 and the second knocking determination part 18 may be connected to the heat generation rate calculation part 12 and the knock determination crank angle region decision part 14 respectively, and the respective processes by the first knocking determination part 16 and the second knocking determination part 18 may be performed in parallel. In this case, if any one of the functional parts (16, 18) determines that knocking is present, the knocking detection device 1 determines that knocking is detected and notifies the ignition timing control device 7 of the detection. Furthermore, the knocking detection device 1 determines that strong knocking has occurred, if any one of the functional parts (17, 18) determines that knocking is strong.

The knocking detection method corresponding to the present embodiment will now be described with reference to FIG. 8. As depicted in FIG. 8, the knocking detection method further includes a second knocking determination step (S4-2: S4a to S4c) of determining that knocking with a strong knocking intensity is detected, if the maximum heat generation rate Q′max is greater than the second knock determination threshold value Lq. This step is a step for carrying out what corresponds to the process of the second knocking determination part 18 described above, and determines that knocking with a strong knocking intensity is detected, if the maximum heat generation rate Q′max is greater than the second knock determination threshold value Lq in the second knocking determination step (S4-2).

According to the order of the flow in FIG. 8, steps S1 to S4 in FIG. 8 are the same as FIG. 2, and the second knocking determination step (S4-2) is carried out between step S4 and step S5 of FIG. 2. More specifically, in step S4a, the maximum heat generation rate Q′max in the knock determination crank angle region Rj is obtained. Then, in next step S4b, the maximum heat generation rate Q′max and the second knock determination threshold value Lq are compared. As a result of the above comparison in step S4b, if the maximum heat generation rate Q′max is greater than the second knock determination threshold value Lq (Q′max>Lq), it is determined that knocking with a strong knocking intensity is detected, in step S4c. In contrast, as a result of the above comparison in step S4b, if the maximum heat generation rate Q′max is not greater than the second knock determination threshold value Lq (Q′max≤Lq), it is determined that knocking with a strong knocking intensity is not detected in the second knocking determination step, and the subsequent steps are carried out. That is, the heat generation rate differentiation step is carried out in the above described step S5, and the first knocking determination step (S6a, S6b, Shy, S6n in FIG. 3) is carried out in step S6. Subsequently, the ignition timing setting not depicted in FIG. 8 may be changed (step S8 or step S9 in FIG. 3), for instance. Furthermore, while the knocking intensity determination step is carried out in step S7 after step S6 in the embodiment depicted in FIG. 8, this is not limitative, and the knocking intensity determination step may be skipped in some other embodiments.

In the example of FIG. 5, in the heat generation rate change curve Cq (s) indicated by the thick solid line, the maximum heat generation rate Q′max of the heat generation rate Q′ in the knock determination crank angle region Rj is the peak value of the second peak, and the peak value of the second peak is greater than the second knock determination threshold value Lq. Thus, a relationship Q′max>Lq is satisfied, and it is determined that knocking with a strong knocking intensity is detected. On the other hand, in the heat generation rate change curve Cq (w) indicated by the thin solid line, the maximum heat generation rate Q′max of the heat generation rate Q′ in the knock determination crank angle region Rj is the peak value of the second peak, but the peak value of the second peak is not greater than the second knock determination threshold value Lq. Thus, a relationship Q′max≤Lq is satisfied, and it is not determined that knocking with a strong knocking intensity is detected. Similarly, in the heat generation rate change curve Cq (n) indicated by the dotted line, the maximum heat generation rate Q′max of the heat generation rate Q′ in the knock determination crank angle region Rj is the peak value of the first peak, and the peak value of the first peak is not greater than the second knock determination threshold value Lq. Thus, a relationship Q′max≤Lq is satisfied, and it is not determined that knocking with a strong knocking intensity is detected.

In the above described embodiments depicted in FIGS. 7 and 8, the maximum heat generation rate Q′max is described as belonging to the knock determination crank angle region Rj. Nevertheless, in some embodiments, the maximum heat generation rate Q′max may be obtained from the all crank angles θ of the combustion cycle, without limiting to the knock determination crank angle region Rj.

With the above configuration, it is possible to detect knocking with a strong knocking intensity quickly. Accordingly, it is possible to prevent damage to the internal combustion engine 2 due to knocking more reliably.

Embodiments of the present invention were described in detail above, but the present invention is not limited thereto, and various amendments and modifications may be implemented.

For instance, the heat generation rate Q′ is calculated by using the in-cylinder pressure P of the cylinder of the internal combustion engine 2, in some other embodiments, for instance, the heat generation rate Q′ may be obtained by directly detecting the heat generation rate Q′, or the heat generation rate Q′ may be calculated by using another physical amount related to the heat generation rate Q′, such as the intensity of light in combustion.

### REFERENCE SIGNS LIST

1 Knocking detection device
11 In-cylinder pressure obtaining part
12 Heat generation rate calculation part
13 In-cylinder pressure maximizing crank angle obtaining part
14 Knock determination crank angle region decision part
15 Heat generation rate differentiation part
16 First knocking determination part
17 Knocking intensity determination part
17a Reference differential heat generation rate obtaining part
17b Knock intensity determination part
18 Second knocking determination part
2 Internal combustion engine
21 Cylinder
22 Piston
23 Connection rod
24 Crank shaft
25 Combustion chamber
25a Pre-combustion chamber
25b Main chamber
25c Nozzle hole
26 Air supply pipe
26v Air supply valve
27 Air discharge pipe
27v Air discharge valve
28 Ignition plug
29 Mixer
29f Fuel supply pipe
29v Fuel adjustment valve
3 In-cylinder pressure sensor
4 Crank angle sensor
7 Ignition timing control device
Q Heat generation amount
Q′ Heat generation rate
Q′max Maximum heat generation rate
Q′b Reference differential heat generation rate
P In-cylinder pressure
PmaxMaximum in-cylinder pressure
θ Crank angle
R Monitoring crank angle region
Rj Knock determination crank angle region
Rb Reference crank angle region
R1 First value
R2 Second value
R3 Third value
Cp In-cylinder pressure change curve
Cq Heat generation rate change curve
Cqd Heat generation rate differentiation curve
Dmax Maximum differential heat generation rate
Dth First knock determination threshold value
L Knock intensity determination threshold value
Lq Second knock determination threshold value

1. A method of detecting knocking in an internal combustion engine, comprising:
an in-cylinder pressure obtaining step of obtaining an in-cylinder pressure of a cylinder of the internal combustion engine at a plurality of crank angles;
a heat generation rate calculation step of calculating a heat generation rate of the cylinder at each of the plurality of crank angles;
an in-cylinder pressure maximizing crank angle obtaining step of obtaining an in-cylinder pressure maximizing crank angle at which the in-cylinder pressure of the cylinder of the internal combustion engine is at a maximum value;
a knock determination crank angle region decision step of deciding a knock determination crank angle region which is a region between a smaller crank angle smaller than the in-cylinder pressure maximizing crank angle by a first value and a larger crank angle larger than the in-cylinder pressure maximizing crank angle by a second value;
a heat generation rate differentiation step of calculating a differential value of the heat generation rate in the knock determination crank angle region; and
a first knocking determination step of determining knocking on the basis of the differential value of the heat generation rate calculated in the heat generation rate differentiation step.

2. The method of detecting knocking according to claim 1,
wherein the first value and the second value are each 3 to 7 angular degrees.

3. The method of detecting knocking according to claim 1,
wherein the first knocking determination step includes obtaining a maximum differential heat generation rate which is a maximum value of the differential value of the heat generation rate calculated in the heat generation rate differentiation step, and determining that knocking is present if the maximum differential heat generation rate is greater than a first knock determination threshold value.

4. The method of detecting knocking according to claim 3, further comprising:
a knocking intensity determination step of determining a magnitude of a knocking intensity of the knocking if it is determined that the knocking is present in the first knocking determination step,
wherein the knocking intensity determination step includes:
a reference differential heat generation rate obtaining step of obtaining a reference differential heat generation rate which is the maximum value of the differential value of the heat generation rate in a reference crank angle region between the smaller crank angle and a crank angle smaller than the smaller crank angle by a third value; and
a knock intensity determination step of determining that the knocking intensity is strong if a magnitude of the maximum differential heat generation rate relative to the reference differential heat generation rate is greater than a knock intensity determination threshold value, and that the knocking intensity is weak if the magnitude of the maximum differential heat generation rate relative to the reference differential heat generation rate is not greater than the knock intensity determination threshold value.

5. The method of detecting knocking according to claim 1, further comprising a second knocking determination step of determining that the detected knocking has a strong knocking intensity if a maximum heat generation rate of the heat generation rate is greater than a second knock determination threshold value.

6. The method of detecting knocking according to claim 1,
wherein the heat generation rate calculation step includes calculating the heat generation rate at each of the plurality of crank angles by using the in-cylinder pressure obtained in the in-cylinder pressure obtaining step.

7. A knocking detection device for detecting knocking in an internal combustion engine comprising an in-cylinder pressure sensor capable of detecting an in-cylinder pressure of a cylinder of the internal combustion engine and a crank angle sensor capable of detecting a crank angle of the internal combustion device, the knocking detection device comprising:
an in-cylinder pressure obtaining part configured to obtain the in-cylinder pressure detected by the in-cylinder pressure sensor at a plurality of the crank angles;
a heat generation rate calculation part configured to calculate a heat generation rate of the cylinder at each of the plurality of crank angles;
an in-cylinder pressure maximizing crank angle obtaining part configured to obtain an in-cylinder pressure maximizing crank angle at which the in-cylinder pressure of the cylinder of the internal combustion engine is at a maximum value;
a knock determination crank angle region decision part configured to decide a knock determination crank angle region which is a region between a smaller crank angle smaller than the in-cylinder pressure maximizing crank angle by a first value and a larger crank angle larger than the in-cylinder pressure maximizing crank angle by a second value;
a heat generation rate differentiation part configured to calculate a differential value of the heat generation rate in the knock determination crank angle region; and
a first knocking determination part configured to determine knocking on the basis of the differential value of the heat generation rate calculated by the heat generation rate differentiation part.

8. The knocking detection device according to claim 7,
wherein the first value and the second value are each 3 to 7 angular degrees.

9. The knocking detection device according to claim 7,
wherein the first knocking determination part is configured to obtain a maximum differential heat generation rate which is a maximum value of the differential value of the heat generation rate calculated by the heat generation rate differentiation part, and determine that knocking is present if the maximum differential heat generation rate is greater than a first knock determination threshold value.

10. The knocking detection device according to claim 9, further comprising:
a knocking intensity determination part configured to determine a magnitude of a knocking intensity of the knocking if it is determined that the knocking is present by the first knocking determination part,
wherein the knocking intensity determination part includes:
a reference differential heat generation rate obtaining part configured to obtain a reference differential heat generation rate which is the maximum value of the differential value of the heat generation rate in a reference crank angle region between the smaller crank angle and a crank angle smaller than the smaller crank angle by a third value; and
a knock intensity determination part configured to determine that the knocking intensity is strong if a magnitude of the maximum differential heat generation rate relative to the reference differential heat generation rate is greater than a knock intensity determination threshold value, and that the knocking intensity is weak if the magnitude of the maximum differential heat generation rate relative to the reference differential heat generation rate is not greater than the knock intensity determination threshold value.

11. The knocking detection device according to claim 7, further comprising a second knocking determination part configured to determine that the detected knocking has a strong knocking intensity if a maximum heat generation rate of the heat generation rate is greater than a second knock determination threshold value.

12. The knocking detection device according to claim 7,
wherein the heat generation rate calculation part is configured to calculate the heat generation rate at each of the plurality of crank angles by using the in-cylinder pressure obtained by the in-cylinder pressure obtaining part.
